(19) United States
(12) Patent Application Publication
(10) Pub. No.: US 2003/0110263 A1
(43) Pub. Date: Jun. 12, 2003

(54) Managing storage resources attached to a data network

(76) Inventor: Avraham Shillo, Sunnyvale, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/279,755

(22) Filed: Oct. 23, 2002

(30) Foreign Application Priority Data
Dec. 10, 2001 (IL) 147073

(51) Int. Cl. G06F 15/173

(52) U.S. Cl. 709/226

(57) ABSTRACT

A computer network includes multiple storage nodes each having a physical storage resource. A system management server on the network identifies the physical storage on the network and collects it into a virtual storage pool. When an application executing on a storages client accesses network storage, the system management server allocates a segment of the virtual storage pool to the application. The segment of the virtual storage pool is stored on a physical storage resource on the network. The system management server monitors the application's use of the network storage and transparently and dynamically re-allocates the virtual segment to an optimal physical storage resource.

### CROSS REFERENCE TO RELATED APPLICATION

This application claims priority under 35 U.S.C. § 119 from Israeli patent application number 147073, filed Dec. 10, 2001.

### BACKGROUND OF THE INVENTION

1. Field of the Invention

The present invention relates to the field of data networks. More particularly, the invention is related to a method for dynamic management and allocation of storage resources attached to a data network to a plurality of workstations also connected to said data network.

2. Background Art

In a typical network computing environment, an amount of available storage is measured in many terabytes, yet the complexity of managing this storage on an organization level complicates the task of achieving its efficient utilization. Many different versions of similar computer files clutter hard disks of users throughout the organization. Attempts to rapidly examine the usage of storage faced substantial implementation problems. Implementing a general storage allocation policy and storage usage analysis from an organization perspective is complicated as well.

In recent years, organizations encountered the problem of being unable to effectively implement and manage a centralized storage policy without centralizing all their storage resources. Otherwise, inconsistencies between different versions of files arise and effective updates become difficult to follow.

In the prior art, a central dedicated file server is used as a repository of computer storage for a network. If the number of files is large, then the file server may be distributed over multiple computer systems. However, with the increase of the volume of the computer storage, the use of dedicated file servers for storage represents a potential bottleneck. The data throughput required for transmitting many files to and from a central dedicated file server, is one of the major factors for the networks' congestion.

The cost of the computer storage attached to dedicated file servers and the complexity of managing this storage grow rapidly as the demand exceeds a certain limit. The necessity of making frequent backups of this storage's content imposes heavier load on dedicated file servers.

As the load on a file server grows, larger parts of its operating system are dedicated to the internal management of the server itself. The complexity of the administration of the file server storage increases as more hardware components are added in order to increase the available storage.

Conventional storage facilities allocate storage resources not as efficiently, since they do not take into consideration the frequency of access to a particular data item. For example, in an e-mail application, access to the inbox folder is much more frequent than access to the deleted items folder. In addition, in many cases, static allocation of storage resources to servers leads to a situation when available storage that can be utilized by other servers is not fully exploited.

Another drawback of conventional storage allocation system is low Quality of Service (QoS). This means that applications which require massive computer resources can be starved, while the needed storage resources are allocated to less intensive applications. Additionally, inefficient storage management and allocation usually results in storage crashes, which also cause the applications that use the crashed storage to crash as well. This is also known as system downtime (the time during which an application is inactive due to failures). Another drawback of conventional storage management systems arises when storage resources should be maintained, upgraded, added or removed. In these cases, several applications (or even all applications) should be suspended, resulting in a further increase in the system downtime.

Therefore, a new approach is needed for efficient management of storage resources and the distribution of files over a data network. With the current state of technology, efficient distribution of data among many disks can be a better solution for data exchange.

It is therefore an object of the present invention to provide a method for dynamically managing and allocating storage resources, which overcomes the drawbacks of prior art.

It is another object of the present invention to provide a method for dynamically managing and allocating storage resources, which reduces the amount of unutilized storage resources.

It is still another object of the present invention to provide a method for dynamically managing and allocating storage resources, which improves the Quality of Service provided to applications which use the storage resources.

It is a further object of the present invention to provide a method for dynamically managing and allocating storage resources, which improves the reliability of the storage resources consumed by the application by reducing system downtime.

It is yet another object of the present invention to provide a method for dynamically managing and allocating storage resources, which dynamically balances the load imposed by each application between the storage resources.

It is still a further object of the present invention to provide a method for dynamically allocating storage resources to applications, in response to storage actual demands imposed by each application.

### BRIEF SUMMARY OF THE INVENTION

The present invention is directed to a method for dynamically managing and allocating storage resources, attached to a data network, to applications executed by users being connected to the data network through access points. The physical storage resource allocated to each application, and the performance of the physical storage resource, are periodically monitored. One or more physical storage resources are represented by a corresponding virtual storage space, which is aggregated in a virtual storage repository. The physical storage requirements of each application are periodically monitored. Each physical storage resource is divided into a plurality of physical storage segments, each of which having performance attributes that correspond to the performance of its physical storage resource. The repository is divided into a plurality of virtual storage segments and each of physical storage segments is mapped to a corresponding virtual storage segment having similar performance attributes. For each application, a virtual storage resource, consisting of a combination of virtual storage segments being optimized for the application according to the performance attributes of their corresponding physical storage segments and the requirements, is introduced. A physical storage space is reallocated to the application by redirecting each virtual storage segment of the combination to a corresponding physical storage segment.

Preferably, the parameters for evaluating performance are the level of usage of data/data files stored in the physical storage resource, by the application; the reliability of the physical storage resource; the available storage space on the physical storage resource; the access time to data stored in the physical storage resource; and the delay of data exchange between the computer executing the application and the access point of the physical storage resource. The performance of each physical storage resource is repeatedly evaluated and the physical storage requirements of each application are monitored. The redirection of each virtual storage segment to another corresponding physical storage segment is dynamically changed in response to changes in the performance and/or the requirements.

Evaluation may performed by defining a plurality of storage nodes, each of which representing an access point to a physical storage resource connected thereto. One or more parameters associated with each storage node are monitored and a dynamic score is assigned to each storage node.

In one aspect, a storage priority is assigned to each storage node. Each virtual storage segment associated with an application having execution priority is redirected to a set of storage nodes having higher storage priority values. The performance of each storage node is dynamically monitored and the storage node priority is changed in response to the monitoring results. Whenever desired, the redirection of each virtual storage segment is changed.

The access time of an application to required data blocks is decreased by storing duplicates of the data files in several different storage nodes and allowing the application to access the duplicate stored in a storage node having the best performance.

Physical storage resources are added to/removed from the data network in a way being transparent to currently executed applications, by updating the content of the repository according to the addition/removal of a physical storage resource, evaluating the performance of each added physical storage resource and dynamically changing the redirection of at least one virtual storage segment to physical storage segments derived from the added physical storage resource and/or to another corresponding physical storage segment, in response to the performance.

A data read operation from a virtual storage resource may be carried out by sending a request from the application, such that the request specifies the location of requested data in the virtual storage resource. The location of requested data in the virtual storage resource is mapped into a pool of at least one storage node, containing at least a portion of the requested data. One or more storage nodes having the shortest response time to fulfill the request are selected from the pool. The request is directed to the selected storage nodes having the lowest data exchange load and the application is allowed to read the requested data from the selected storage nodes.

A data write operation from a virtual storage resource is carried out by sending a request from the application, such that the request determines the data to be written, and the location in the virtual storage resource to which the data should be written. A pool of potential storage nodes for storing the data is created. At least one storage node, whose physical location in the data network has the shortest response time to fulfill the request, is selected from the pool. The request is directed to the selected storage nodes having the lowest data exchange load and the application is allowed to write the data into the selected storage nodes.

Each application can access each storage node by using a computer linked to at least one storage node and having access to physical storage resources which are inaccessible by the application as a mediator between the application and the inaccessible storage resources.

Preferably, the data throughput performance of each mediator is evaluated for each application, and the load required to provide accessibility to inaccessible storage resources, for each application, is dynamically distributed between two or more mediators, according to the evaluation results.

Physical storage space is re-allocating for each application by redirecting the virtual storage segments that correspond to the application to two or more storage nodes, such that the load is dynamically distributing between the two or more storage nodes, according their corresponding scores, thereby balancing the load between the two or more storage nodes.

The re-allocation of the physical storage resources to each application may be carried out by continuously, or periodically, monitoring the level of demand of actual physical storage space, allocating actual physical storage space for the application in response to the level of demand for the time period during which the physical storage space is actually required by the application, and by dynamically changing the level of allocation in response to changes in the level of the demand.

The present invention is also directed to a system for dynamically managing and allocating storage resources, attached to a data network, to applications executed by users being connected to the data network through access points, operating according the method described hereinabove.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 schematically illustrates the architecture of a system for dynamically managing and allocating storage resources to application servers/workstations, connected to a data network, according to a preferred embodiment of the invention;

FIG. 2 schematically illustrates the structure and mapping between physical and virtual storage resources, according to a preferred embodiment of the invention; and

FIGS. 3A and 3B schematically illustrate read and write operations performed in a system for dynamically managing and allocating storage resources to application servers/workstations connected to a data network, according to a preferred embodiment of the invention.

### DETAILED DESCRIPTION OF THE INVENTION

The present invention comprises the following components:

a Storage Domain Supervisor, located on a System Management server for managing a storage allocation policy and distributing storage to storage clients;

Storage Node Agents, located on every computer that has a usable storage space on its hard disks; and

Storage Clients, located on every computer that needs to use the storage space.

A more detailed explanation of the task of each of these components will be given herein below.

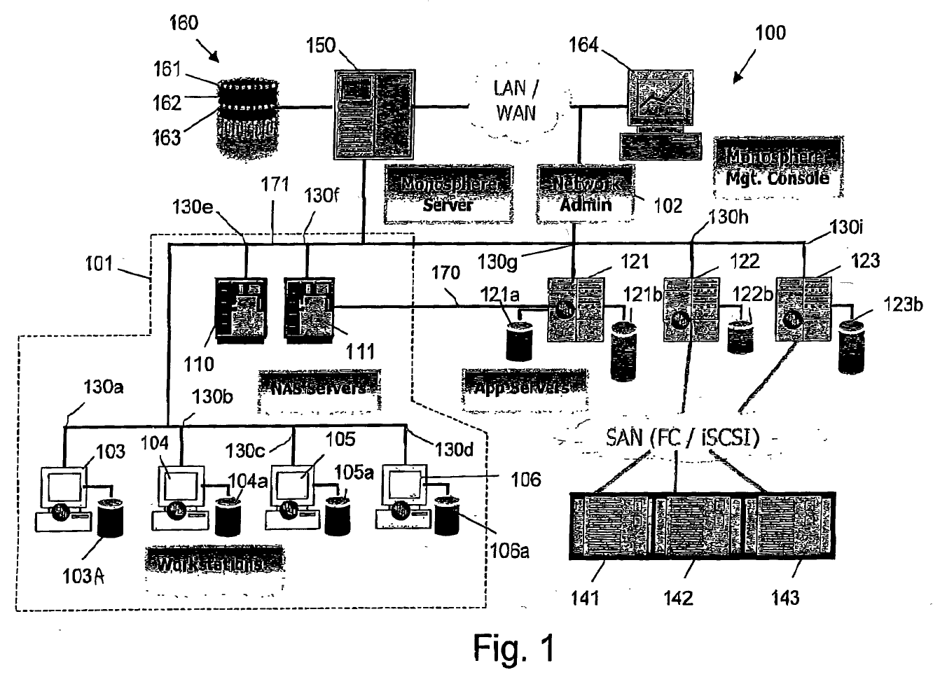

FIG. 1 schematically illustrates the architecture of a system for dynamically managing and allocating storage resources to application servers/workstations connected to a data network, according to a preferred embodiment of the invention. The data network 100 includes a Local-Area-Network (LAN) 101 that comprises a network administrator 102, a plurality of workstations 103 to 106, each of which having a local storage 103a to 106a, respectively, and a plurality of Network-Area-Storage (NAS) servers 110 and 111, each of which contains large amounts of storage space, for the LAN's usage. The NAS servers 110 and 111 conduct a continuous communication (over communication path 170) with application servers 121 to 123, which are connected to LAN 100, and where applications used by the workstations 102 to 105 are run. This communication path 170 is used to temporarily store data files required for running the applications by workstations in the LAN 101 . The application servers 121 to 123 may contain their own (local storage) hard disk 121a, or they can use storage services provide by an external Storage Area Network (SAN) 140, by utilizing several of its storage disks 141 to 143. Each access point of an independent storage resource (a physical storage component such as a hard disk), to the network is referred to as a storage node.

Under existing technologies, each of the application servers 121 to 123 would store its applications' data on its own respective hard disk 121a (if sufficient, or its corresponding disk 141 to 143, allocated by the SAN 140. In order to overcome the drawbacks of unused storage space, system downtime, and inadequate Quality of Service a managing server 150 is added to the network administrator 101. The managing server 150 identifies all the physical storage resources (i.e., all the hard-disks) that are connected to the network 100 and collects them into a virtual storage pool 160, which is actually implemented by a plurality of segments that are distributed, using predetermined criteria that are dynamically processed and evaluated, among the physical storage resources, such that the distribution is transparent to each application. In addition, the managing server 150 monitors (by running the Storage Domain Supervisor component installed therein) all the various applications that are currently being used by the network's workstations 103 to 106. The server 150 can therefore detect how much disk space each application actually consumes from the application server that runs this application. Using this knowledge and criteria, server 150 re-allocates virtual storage resources to each application according to its actual needs and the level of usage. The server 150 processes the collected knowledge, in order to generate dynamic indications to the network administrator 102, for regulating and re-allocating the available storage space among the running applications, while introducing, to each application, the amount of virtual storage space expected by that application for proper operation. The server 150 is situated so that it is parallel to the network communication path 171 between the LAN 101 and the application servers 121 to 123. This configuration assures that the server 150 is not a bottleneck to the data flowing through communication path 171, and thus, data, congestion is eliminated.

The re-allocation process is based on the fact that many applications, while consuming great quantities of disk resources, actually utilize only parts of these resources. The remaining resources, which the applications do not utilize, are only needed for the applications to be aware of, but not operate on. For example, an application may consume 15 GB of memory, while only 10 GB are actually used in the disk for installation and data files. In order to properly operate, the application requires the remaining 5 GB to be available on its allocated disk, but hardly ever (or never) uses them. The re-allocation process takes over these unused portions of disk resources, and allocates them to applications that need them for their actual operation. This way, the network's virtual storage volume can be sized above the actual physical storage space. This increases the flexibility of the network, up to the limit of its operating system's formatting capability of the physical storage space. Allocation of the actual physical storage space is performed for each application on demand (dynamically), and only for the time period during which it is actually required by that application. The level of demand is continuously, or periodically, monitored and if a reduction in the level of the demand is detected, the amount of allocated physical storage space is reduced accordingly for that application, and may be allocated for other applications which currently increase their level of demand. The same may be done for allocating a virtual storage resource for each application.

A further optional feature that can be carried out by the system is its liquidity—which is an indication of how much additional storage resources the system should allocate for immediate use by an application. Liquidity provides better storage allocation performance and ensures that an application will not run out of storage resources; due to an unexpected increase in storage demand. Storage volume usage indicators alert the System Manager before the application runs out of available storage resources.

Yet a further optional feature of the system is its accessibility—which allows an application server to access all of the network's storage devices (storage nodes), even if some of those storage devices can only be accessed by a limited number of computers within the network. This is achieved by using computers which have access to inaccessible disks to act as mediators and induce their access to applications which request the inaccessible data. The data throughput performance of each mediator (i.e., the amount of data handled successfully by that mediator in a given time period) is evaluated specifically for each application, and the load required to fulfill the accessibility is dynamically distributed between different mediators for each application according to the evaluation results (load balancing between mediators).

In order to assure that the applications whose resources were exempted will still run without failures, the server 150 creates virtual storage volumes 161, 162 and 163 (in the virtual storage pool 160), for application servers 121, 122 and 123, respectively. These virtual volumes are reflected as virtual disks 121b, 122b and 123b. This means that even though an application does not have all the physical disk resources required for running, it receives an indication from the network administrator 102 that all of these resources are available for it, where in fact its un-utilized resources are allocated to other applications. The application servers, therefore, only have knowledge about the sizes of their virtual disks instead of their physical disks. Since the resource demands of each application vary constantly, the sizes of the virtual disks seen by the application servers also vary. Each virtual storage volume is divided into predetermined storage segments (“chunks”), which are dynamically mapped back to a physical storage resource (e.g., disks 121a, 141 to 143) by distributing them between corresponding physical storage resources.

A storage node agent is provided for each storage node, which is a software component that executes the redirection of data exchange between allocated physical and virtual storage resources. According to a preferred embodiment of the invention, the resources of each storage node that is linked to an end user's workstation, are also added to the virtual storage pool 160. Mapping is carried out by defining a plurality of storage nodes, 130a to 130i, each of which being connected to a corresponding physical storage resource. Each storage node is evaluated and characterized by performance parameters, derived from the predetermined criteria, for example, the available physical storage on that node, the resulting data delay to reach that node over the data network, access time to the disk that is connected to that storage node, etc.

In order to optimize the re-allocation process, server 150 dynamically evaluates each storage node and, for each application, distributes (by allocation) physical storage segments that correspond to that application between storage nodes that are found optimal for that application, in a way that is transparent to the application. Each request from an application to access its data files is directed to the corresponding storage nodes that currently contain these data files. The evaluation process is repeated and data files are moved from node to node according to the evaluation results.

The operation of server 150 is controlled from a management console 164, which communicates with it via a LAN/WAN 165, and provides dynamic indications to the network administrator 102.

Server 150 comprises pointers to locations in the virtual storage pool 160 that correspond to every file in the system, so an application making a request for a file need not know its actual physical location. The virtual storage pool 160 maintains a set of tables that map the virtual storage space to the set of physical volumes of storage located on different disks (storage nodes) throughout the network.

Any client application can access every file on every storage disk connected to a network through the virtual storage pool 160. A client application identifies itself during forwarding a request for data, so its security level of access can be extracted from an appropriate table in the virtual storage pool 160.

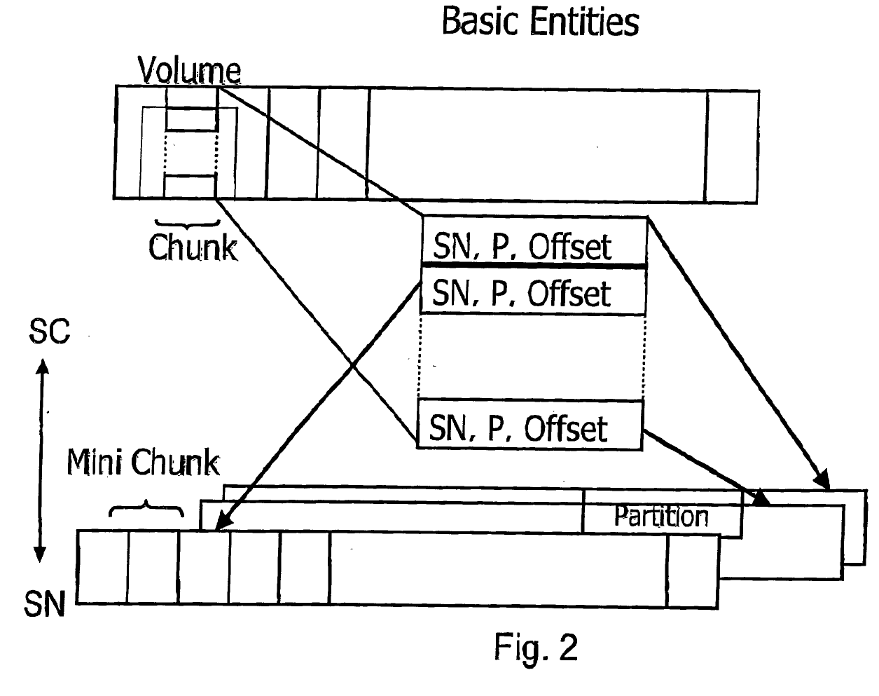

FIG. 2 schematically illustrates the structure and mapping between physical and virtual storage resources, according to a preferred embodiment of the invention. Each virtual storage volume (e.g., 161) that is associated with each application is divided to equal storage “chunks”, which are sub-divided into segments, such that each segment is associated (as a result of continuous evaluation) with an optimal storage node. Each segment of a chunk is mapped through its corresponding optimal storage node into a “mini-chunk”, located at a corresponding partition of the disk that is associated with that node. As seen from the figure, each chunk may be mapped (distributed between) to a plurality of disks, each of which having different performances and located at different location on the data network.

The hierarchical architecture proposed by the invention allows scalability of the storage networks while essentially maintaining its performance. A network is divided into areas (for example separate LANs), which are connected to each other. A selected computer in each predetermined area maintains a local routing table that maps the virtual storage space to the set of physical storage resources located in this area. Whenever access to a storage volume which it is not mapped is required, the computer seeks the location of the requested storage volume in the virtual storage pool 160, and accesses its data. The local routing tables are updated each time the data in the storage area is changed. Only the virtual storage pool 160 maintains a comprehensive view of the metadata (i.e., data related to attributes, structure and location of stored data files) changes for all areas. This way, the number of times that the virtual storage pool 160 should be accessed in order to access to files in any storage node on the network is minimized, as well as the traffic of metadata required for updating the local routing tables, particularly for large storage networks.

The physical storage resources may be implemented using a Redundant Array Of Independent Disks (RAID—a way of redundantly storing the same data on multiple hard-disks (i.e., in different places)). Maintaining multiple copies of files is a much more cost-efficient approach, since there is no operational delay involved in their restoration, and the backup of those files can be used immediately.

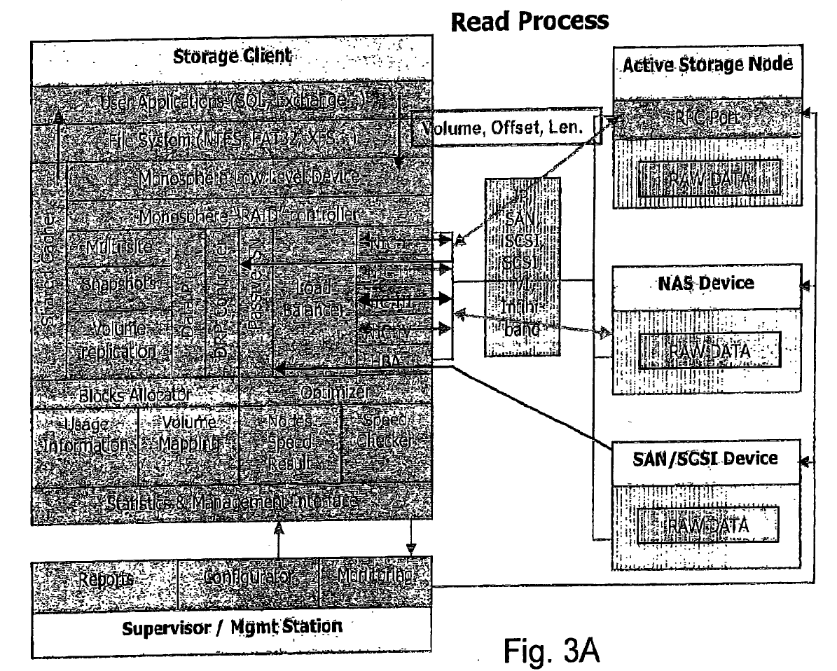

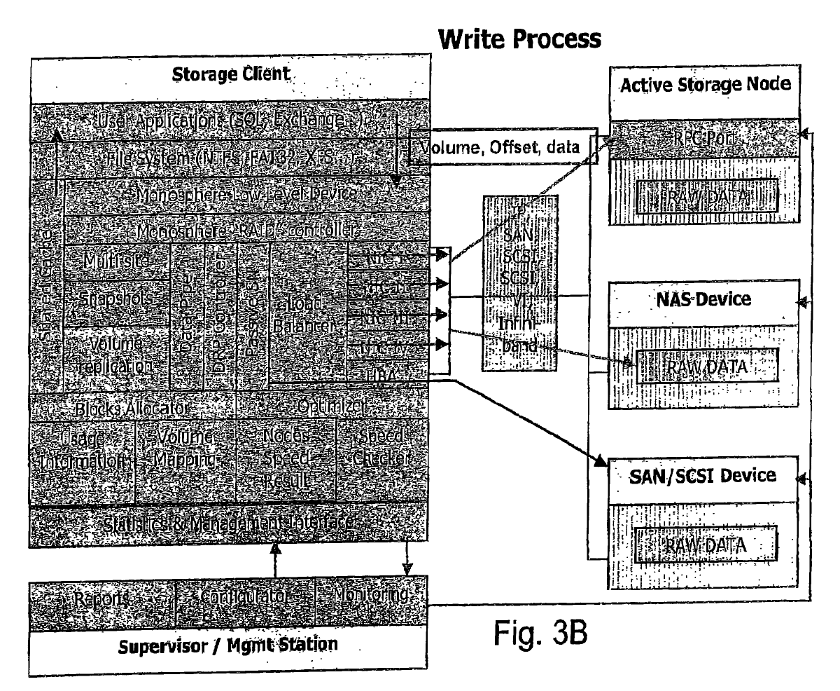

FIGS. 3A and 3B schematically illustrate read and write operations performed in a system for dynamically managing and allocating storage resources to application servers/workstations, connected to a data network, according to a preferred embodiment of the invention.

In a read operation, a user application (running on a storage client) makes a request to read certain data, and adds three parameters to this request—which virtual volume to read from, the offset of the requested data within the volume, and the length of the data. This request is forwarded through the File System, and accesses the Low Level Device component of the storage client, which is typically a disk. The Low Level Device then calls the Blocks Allocator. The Blocks Allocator uses the Volume Mapping table to convert the virtual location (the allocated virtual drive in the virtual storage pool 160) of the requested data (as specified by the volume and offset parameters of the request), into the physical location (the storage node) in the network, where this data is actually stored.

Often, there are cases when the requested data is written in more than one location in the network. In order to decide from which storage nodes it's best to retrieve data, the storage client periodically sends a request for a file read to each storage node in the network, and measures the response time. It then builds a table of the optimal storage nodes having the shortest read access time (highest priority) with respect to the Storage Client's location. The Load Balancer uses this table to calculate the best storage nodes to retrieve the requested data from. Data can be retrieved from the storage node having the highest priority. Alternatively, if the storage node having the highest priority is congested due to parallel requests from other applications, data is retrieved from another storage node, having similar or next-best priority. Since the performance of each storage node is continuously (or periodically) evaluated for each application, data retrieval can be dynamically distributed between different all storage nodes containing portions of the required data for each application according to the evaluation results (load balancing between storage nodes). The combination of storage nodes used for each read operation varies with respect to each application in response to variations in the evaluation results.

After the retrieval location has been determined, the RAID Controller, which is in charge of I/O operations in the system, sends the request through the various network communication cards. It then accesses the appropriate storage nodes, and retrieves the requested data.

The write operation is performed similarly. The request for writing data received from the user application again has three parameters, only this time, instead of the length of the data (which appeared in the read operation), there is now the actual data to be written. The initial steps are the same, up to the point where the Blocks Allocator extracts the exact location into which the data should be written, from the Volume Mapping table. Next, the Blocks Allocator uses the Node Speed Results, and the Usage Information tables, to check all available storage nodes throughout the network, and form a pool of potential storage space for writing the data. The Blocks Allocator allocates storage necessary for creating at least two duplicates of a data block for each request to create a new data file by a user.

In order to select the storage nodes from the pool, for the allocation of storage in a most efficient way, the Load Balancer evaluates each remote storage node according to priority determined by the following parameters:

The amount of storage remaining on the storage node.

Other requests for accessing data from other applications directed to this storage node.

Data congestion in the path for reaching that node.

Data is written to the storage node having the highest priority, or alternatively, by continuously (or periodically) evaluating the performance of each storage node for each application. Data write operations can be dynamically distributed for each application between different (or even all) storage nodes, according to the evaluation results (load balancing between storage nodes). The combination of storage nodes used for each write operation varies with respect to each application in response to variations in the evaluation results.

After the storage nodes to be used are selected, the RAID Controller issues a write request to the appropriate NAS and SAN devices, and sends them the data via the various network communication cards. The data is then received and saved in the appropriate storage nodes inside the appropriate NAS and SAN devices.

Since requests for data stored on a network by its users change continuously, the storage distribution of this data is modified dynamically in response to the changing storage requests. Ultimately, the number of instances of this data is optimized, according to the users' demand for it, and its physical location among the different storage nodes on a network is changed as well. The system thus adjusts itself continuously until an optimal configuration is achieved.

According to a preferred embodiment of the invention, multiple duplicates of every file are stored at least on two different nodes in the network for backup in case of a system failure. The file usage patterns, stored in the profile table associated with that file, are evaluated for each requested file. Data throughput over the network in increased by eliminating access contention for a file by evaluation and storing duplicates of the file in separate storage nodes on the network, according to the evaluation results.

File distribution can be performed by generating multiple file duplicates simultaneously in different nodes of a network, rather than by a central server. Consequently, the distribution is decentralized and bottleneck states are eliminated

The mapping process is performed dynamically, without interrupting the application. Hence, new storage disks may be added to the data network by simply registering them in the virtual storage pool.

An updated metadata about the storage locations of every duplicate of every file and about every block (small-sized storage segment on a hard disk) of storage comprising those files is maintained dynamically in the tables of the virtual storage pool 160.

The level of redundancy for different files is also set dynamically, where files with important data are replicated in more locations throughout the network, and are thus better protected from storage failures.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A system for managing storage resources on a network, comprising:
a plurality of storage nodes on the network, each node associated with a physical storage resource;
a management server on the network for collecting the physical storage resources associated with the storage nodes into a pool of virtual storage resources; and
a storage client for accessing the virtual storage resources in the pool collected by the management server.

2. The system of claim 1, wherein the pool of virtual storage is comprised of a plurality of virtual segments, and wherein the virtual segments are adapted to be stored on the physical storage resources.

3. The system of claim 2, wherein the virtual segments are arranged in virtual storage volumes and wherein the virtual storage volumes appear as physical storage resources to the storage client.

4. The system of claim 1, wherein a total virtual storage in the pool exceeds a total of the physical storage resources on the network.

5. The system of claim 1, wherein the management server is adapted to monitor accesses to virtual storage resources by the storage client and dynamically allocate the virtual storage resources to physical storage resources responsive to the accesses.

6. The system of claim 5, wherein the physical storage resources are characterized by performance parameters and wherein the management server dynamically allocates the virtual storage resources to the physical storage resources responsive to the performance parameters and characteristics of the accesses made by the storage client.

7. The system of claim 5, wherein the dynamic allocation is transparent to the storage client.

8. The system of claim 5, wherein the management server is adapted to dynamically allocate the virtual storage resources to physical storage resources responsive to the storage client's level of usage of the virtual storage.

9. The system of claim 5, wherein the storage client is adapted to execute a plurality of applications and wherein the management server is adapted to monitor access to virtual storage resources by ones of the plurality of applications and dynamically allocate the virtual storage to each of the plurality of applications responsive to the application's accesses.

10. The system of claim 1, wherein the storage client accesses data held by a plurality of virtual storage resources and wherein the storage client is further adapted to test the plurality of virtual storage resources holding the data and identify a set of optimal virtual storage resource from which to access the data.

11. The system of claim 10, wherein the storage client further comprises:
a load balancer adapted to select a virtual storage resource in the set from which to access the data.

12. The system of claim 1, wherein a storage node on the network is inaccessible to the storage client but accessible to a mediator computer system, and wherein the management server is adapted to utilize the mediator computer system to enable the storage client to access the physical storage associated with the storage node.

13. The system of claim 1, wherein the network comprises a plurality of areas, each area including a plurality of storage nodes, further comprising:
a computer system having a local routing table for mapping the pool of virtual storage resources to the physical storage resources associated with the plurality of storage nodes in one of the areas.

14. A computer program product comprising:
a computer-readable medium having computer program logic embodied therein for maintaining storage resources on a network, the network comprising a plurality of storage nodes, each node associated with a physical storage resource, the network further comprising a storage client for accessing the storage resources, the computer program logic comprising:
management server logic for collecting the physical storage resources associated with the storage nodes into a pool of virtual storage resources and for providing virtual storage resources in the pool to the storage client.

15. The computer program product of claim 14, wherein the pool of virtual storage is comprised of a plurality of virtual segments, and wherein the virtual segments are adapted to be stored on the physical storage resources.

16. The computer program product of claim 15, wherein the virtual segments are arranged in virtual storage volumes and wherein the virtual storage volumes appear as physical storage resources to the storage client.

17. The computer program product of claim 14, wherein the management server logic is further adapted to monitor accesses to storage resources by the storage client and dynamically allocate the virtual storage resources to physical storage resources responsive to the accesses.

18. The computer program product of claim 17, wherein the physical storage resources are characterized by performance parameters and wherein the management server logic dynamically allocates the virtual storage resources to the physical storage resources responsive to the performance parameters and characteristics of the accesses made by the storage client.

19. The computer program product of claim 17, wherein the storage client is adapted to execute a plurality of applications and wherein the management server logic is adapted to monitor access to storage resources by ones of the plurality of applications and dynamically allocate virtual storage resources to each of the plurality of applications responsive to the application's accesses.

20. The computer program product of claim 14, wherein the storage client accesses data held by a plurality of virtual storage resources, further comprising:
testing logic for testing the plurality of virtual storage resources holding the data and identifying a set of optimal virtual storage resource from which the storage client should access the data.

21. The computer program product of claim 20, further comprising:
load balancer logic for selecting a virtual storage resource in the set from which the storage client accesses the data.

22. A method of managing storage resources on a network, comprising:
identifying a plurality of storage nodes on the network, each node associated with a physical storage resource;
collecting the physical storage resources associated with the storage nodes into a pool of virtual storage resources; and
providing virtual storage resources from the pool to a storage client responsive to the storage client accessing the storage resources on the network.

23. The method of claim 22, wherein the pool of virtual storage is comprised of a plurality of virtual segments, and wherein the virtual segments are distributed among the physical storage resources.

24. The method of claim 23, wherein the virtual segments are arranged in virtual storage volumes and wherein the virtual storage volumes appear as physical storage resources to the storage client.

25. The method of claim 22, wherein the providing step comprises:
monitoring the storage client's accesses to virtual storage; and
dynamically allocating the virtual storage resources to physical storage resources responsive to the accesses.

26. The method of claim 25, wherein the physical storage resources are characterized by performance parameters and wherein the dynamically allocating step comprises:
allocating the virtual storage resources to the physical storage resources responsive to the performance parameters and characteristics of the accesses made by the storage client.

27. The method of claim 25, wherein the dynamically allocating step comprises:
allocating the virtual storage resources to physical storage resources responsive to the storage client's level of usage of the virtual storage.

28. The method of claim 22, wherein the storage client accesses data held by a plurality of virtual storage resources and further comprising:
testing the plurality of virtual storage resources holding the data; and
responsive to the testing, identifying a set of optimal virtual storage resource from which the storage client can access the data.

29. The method of claim 28, further comprising:
selecting a virtual storage resource in the set from which the storage client will access the data.

30. The method of claim 22, further comprising:
identifying a new storage node on the network, the new storage node associated with a new physical storage resource; and
allocating a portion of the virtual storage resources to the new physical storage resource.
